(19) United States
(12) Patent Application Publication
(10) Pub. No.: US 2014/0038011 A1
(43) Pub. Date: Feb. 6, 2014

(54) MOLTEN-SALT ELECTROLYTE BATTERY DEVICE

(71) Applicants: Atsushi Fukunaga, Osaka-shi (JP); Shinji Inazawa, Osaka-shi (JP); Koji Nitta, Osaka-shi (JP); Shoichiro Sakai, Osaka-shi (JP)

(72) Inventors: Atsushi Fukunaga, Osaka-shi (JP); Shinji Inazawa, Osaka-shi (JP); Koji Nitta, Osaka-shi (JP); Shoichiro Sakai, Osaka-shi (JP)

(73) Assignee: SUMITOMO ELECTRIC INDUSTRIES, LTD., Osaka-shi, Osaka (JP)

(21) Appl. No.: 14/112,907

(22) PCT Filed: Apr. 6, 2012
(86) PCT No.: PCT/JP2012/059456

§ 371 Date: Oct. 18, 2013

(30) Foreign Application Priority Data
Apr. 18, 2011 (JP) 2011-091778

(51) Int. Cl. H01M 10/50; H01M 10/39

(52) U.S. Cl. CPC H01M 10/5024; H01M 10/399
USPC 429/62

(57) ABSTRACT

Safe molten-salt electrolyte battery device that can quickly decrease the temperature of a molten-salt electrolyte battery when abnormal heat generation occurs in the battery is provided. A molten-salt electrolyte battery device according to the present invention is provided with a molten-salt electrolyte battery which uses a molten-salt electrolyte and includes a temperature detection means which detects the temperature of the molten-salt electrolyte battery, a cooling means which cools the molten-salt electrolyte battery with a cooling medium, and a control means into which a signal from the temperature detection means is inputted and which outputs an operation instruction to the cooling means. When the molten-salt electrolyte battery device is used, in the case where abnormal heat generation occurs in the molten-salt electrolyte battery, the molten-salt electrolyte battery is cooled by the cooling medium, and therefore, the temperature of the battery can be quickly decreased to a safe temperature.

### TECHNICAL FIELD

The present invention relates to a molten-salt electrolyte battery device provided with a molten-salt electrolyte battery.

### BACKGROUND ART

In recent years, electronic devices, such as mobile phones, mobile computers, and digital cameras, have rapidly become widespread, and the demand for small-size secondary batteries has been rapidly increasing. Furthermore, in the power and energy fields, power generation using natural energy, such as sunlight and wind power, has been conducted actively, and in order to level the weather- and climate-dependent unstable supply of power, secondary batteries for energy storage are indispensable.

As a secondary battery suitably used for such a purpose, a molten-salt electrolyte battery having a high energy density and a large capacity is receiving attention. This molten-salt electrolyte battery uses a molten-salt electrolyte and is configured to perform discharging and charging by keeping the molten-salt electrolyte in a molten state at a predetermined temperature (for example, refer to Patent Literature 1).

Other examples of the secondary battery include a sodium-sulfur battery disclosed in Patent Literature 2, a lead storage battery, and a molten-salt electrolyte battery which has been recently proposed and disclosed in Patent Literature 3 and which operates at a relatively low temperature.

This molten-salt electrolyte battery uses a molten-salt electrolyte and is configured to perform discharging and charging by keeping the molten-salt electrolyte in a molten state at a predetermined temperature.

### CITATION LIST

### Patent Literature

PTL 1: Japanese Unexamined Patent Application Publication No. 8-138732
PTL 2: Japanese Unexamined Patent Application Publication No. 2007-273297
PTL 3: International Publication No. WO/2011/036907

### SUMMARY OF INVENTION

### Technical Problem

In a molten-salt electrolyte battery, when the temperature increases abnormally because of short-circuiting or the like, various gases are generated by chemical reactions, resulting in the possibility that the pressure may increase inside the battery case. At the time of such abnormal heat generation, the heater, which is provided in order to heat the molten-salt electrolyte battery to a predetermined temperature (e.g., 80° C. to 95° C.), is turned off.

Furthermore, since it is necessary to maintain the molten-salt electrolyte battery at a temperature equal to or higher than the temperature at which the molten-salt electrolyte melts, an insulating structure is generally provided on the outer periphery of the molten-salt electrolyte battery. For example, the molten-salt electrolyte battery is housed in an insulating container. Consequently, at the time of abnormal heat generation, even when the heater is turned off to stop heating, it takes time to decrease the temperature of the molten-salt electrolyte battery. Thus, stopping of the heating alone is not sufficient to prevent trouble such as an explosion of the battery case due to gas generation, which is a problem.

Furthermore, when a molten-salt electrolyte battery is rapidly discharged, the temperature in the battery rises suddenly, resulting in a change in battery characteristics, which is a problem.

There has been a demand for a molten-salt electrolyte battery device that can cope with a sudden temperature rise occurring at the time of abnormal trouble or during rapid discharging as in the case described above.

The present invention has been achieved in consideration of the problems described above. It is an object of the present invention to provide a safe molten-salt electrolyte battery device that can quickly decrease the temperature of a molten-salt electrolyte battery when abnormal heat generation occurs in the battery.

### Solution to Problem

A molten-salt electrolyte battery device according to the present invention is provided with a molten-salt electrolyte battery which uses a molten-salt electrolyte and includes a temperature detection means which detects the temperature of the molten-salt electrolyte battery, a cooling means which cools the molten-salt electrolyte battery with a cooling medium, and a control means into which a signal from the temperature detection means is inputted and which outputs an operation instruction to the cooling means (claim 1).

When the molten-salt electrolyte battery device is used, in the case where abnormal heat generation occurs in the molten-salt electrolyte battery, the molten-salt electrolyte battery is cooled by the cooling medium, and therefore, the temperature of the battery can be quickly decreased to a safe temperature.

Furthermore, in the molten-salt electrolyte battery device according to the present invention, preferably, the device further includes a heating means which heats the molten-salt electrolyte battery and a heating interception means which shuts off the power of the heating means, and the control means further outputs an operation instruction to the heating interception means (claim 2).

In the case where abnormal heat generation occurs in the molten-salt electrolyte battery, by shutting off the power of the heating means which is provided in order to heat the molten-salt electrolyte battery to a predetermined temperature, the molten-salt electrolyte battery is not further heated, and the temperature of the battery can be decreased more efficiently.

Furthermore, in the molten-salt electrolyte battery device according to the present invention, preferably, the control means outputs an operation instruction to the heating interception means when the temperature of the molten-salt electrolyte battery becomes a predetermined first temperature or higher, and the control means outputs an operation instruction to the cooling means when the temperature of the molten-salt electrolyte battery becomes a second temperature or higher, the second temperature being higher than the first temperature (claim 3).

In the case where abnormal heat generation occurs in the molten-salt electrolyte battery and the temperature becomes the predetermined first temperature or higher, first, by shutting off the power of the heating means, an attempt is made to decrease the temperature of the battery. In the case where the temperature of the battery is decreased to a safe temperature, cooling with a cooling medium is not performed. However, in the case where, even when the power of the heating means is shut off, the temperature of the battery further rises and becomes equal to or higher than the second temperature which is higher than the first temperature, the battery is cooled using a cooling medium.

In such a manner, when a large amount of heat is generated such that the temperature is not decreased only by shutting off of the power of the heating means, cooling is performed using a cooling medium in order to decrease the temperature to a safe temperature quickly. When a very small amount of heat is generated such that the temperature is decreased by shutting off of the power of the heating means, the temperature of the battery is not decreased excessively, and it is possible to quickly perform heating to a temperature that is equal to or higher than the temperature at which the molten-salt electrolyte melts in the process of operating the battery again, thus being efficient.

Furthermore, in the molten-salt electrolyte battery device according to the present invention, preferably, the cooling means cools the molten-salt electrolyte battery at least to a temperature at which the molten-salt electrolyte coagulates (claim 4).

The molten-salt electrolyte battery performs discharging and charging in a state in which the molten-salt electrolyte is melted. In other words, when the temperature becomes a predetermined temperature or lower (e.g., room temperature) and the molten-salt electrolyte coagulates, reactions, such as discharging, charging, and gas generation, do not occur. On the other hand, in a lithium battery, nickel metal hydride battery, or the like, battery reactions continue even when the temperature becomes lower than room temperature (e.g., −20° C.). Consequently, in the case where the temperature of the battery increases abnormally for some reason, even if a lithium battery, nickel metal hydride battery, or the like is cooled, it is not necessarily safe. In contrast, when a molten-salt electrolyte battery is cooled, for example, to about room temperature, reactions, such as discharging, charging, and gas generation, do not occur, and thus the molten-salt electrolyte battery is safe.

Furthermore, in the molten-salt electrolyte battery device according to the present invention, preferably, the cooling medium used for cooling is liquid nitrogen (claim 5). Since liquid nitrogen has a lower temperature than other cooling mediums (e.g., water), it can effectively cool the molten-salt electrolyte battery. Furthermore, liquid nitrogen has high versatility and is easy to handle compared with liquid hydrogen, liquid helium, or the like which has a lower temperature than liquid nitrogen. Furthermore, since nitrogen does not react with the salt of the molten-salt electrolyte battery, the battery is not degraded or damaged. When the temperature of the battery is increased again to melt the molten-salt electrolyte, it is possible to discharge and charge the battery again.

As the cooling means, a water-cooled type cooling means or air-cooled type cooling means, which is generally used, is preferable (claim 6). This means has proven good performance and has a low operational cost.

Furthermore, in the molten-salt electrolyte battery device according to the present invention, preferably, the molten-salt electrolyte battery is housed in an insulating container (claim 7).

When the molten-salt electrolyte battery is housed in an insulating container, by only turning off of the power of the heating means, it takes a long time to decrease the temperature of the battery. Therefore, it is effective to cool the battery with a cooling medium.

### Advantageous Effects of Invention

According to the present invention, when abnormal heat generation occurs in the molten-salt electrolyte battery, the temperature of the battery can be quickly decreased and battery reactions can be stopped safely.

### BRIEF DESCRIPTION OF DRAWINGS

FIG. 1 is a block diagram showing an example of a structure of a molten-salt electrolyte battery device.

FIG. 2 is a schematic view showing an example of a cooling means.

FIG. 3 is a schematic view showing an example of a cooling means.

FIG. 4 is a schematic view showing an example of a cooling means.

FIG. 5 is a schematic top view showing an example of a structure of a molten-salt electrolyte battery.

FIG. 6 is a schematic perspective front view of a molten-salt electrolyte battery.

FIG. 7 is a schematic oblique perspective view showing a structure of a molten-salt electrolyte battery unit and a cooling means.

### REFERENCE SIGNS LIST

1 molten-salt electrolyte battery device
11 positive electrode
12, 22 tab
13, 23 tab lead
15 molten-salt electrolyte battery unit
18 molten-salt electrolyte battery
21 negative electrode
31 separator
4 control means
5 cooling means
51 cooling medium
53, 55, 57 cooling medium container
54 jet orifice
56 bottom plate
58 nozzle
59 vessel
6 battery case
61, 62 side wall
7 molten-salt electrolyte
81 heating means
82 heating interception means
83 heater
85 temperature detection means
9 insulating container

### DESCRIPTION OF EMBODIMENTS

The present invention will be described below on the basis of embodiments. It is to be noted that the present invention is not limited to the embodiments described below, and various modifications can be made to the following embodiments within the scope that is the same as and equivalent to that of the present invention.

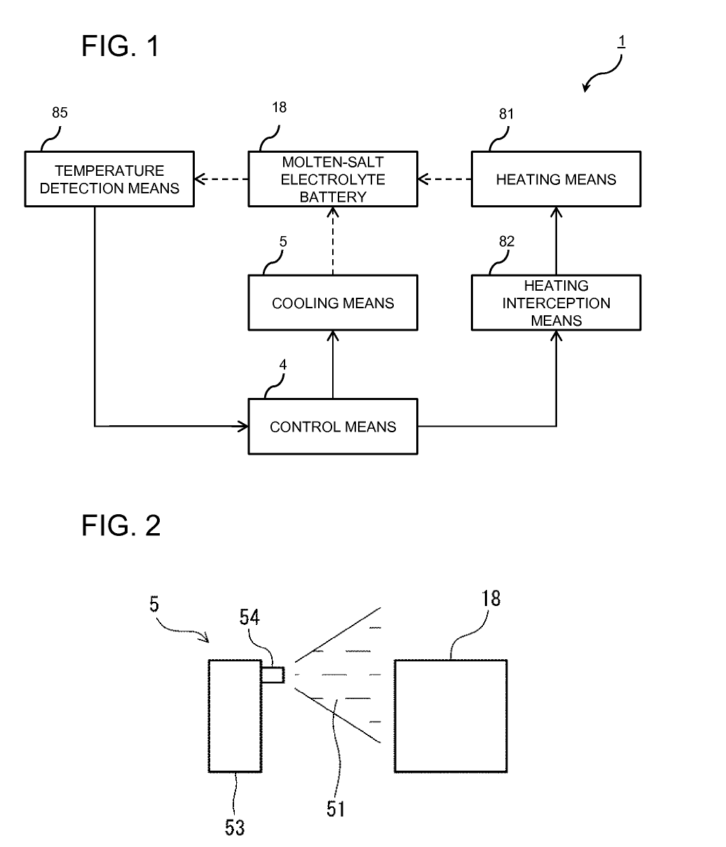

FIG. 1 is a block diagram showing an example of a structure of a molten-salt electrolyte battery device 1. The molten-salt electrolyte battery device 1 includes a molten-salt electrolyte battery 18, a temperature detection means 85 which detects the temperature of the molten-salt electrolyte battery 18, and a cooling means 5 which cools the molten-salt electrolyte battery 18 with a cooling medium. The temperature detection means 85 is not particularly limited, and a commercially available temperature sensor, thermocouple, or the like may be used. Furthermore, the molten-salt electrolyte battery device 1 includes a control means 4 into which a signal from the temperature detection means 85 is inputted and which outputs an operation instruction to the cooling means 5.

Furthermore, the molten-salt electrolyte battery device 1 includes a heating means 81 which heats the molten-salt electrolyte battery 18 and a heating interception means 82 which shuts off the power of the heating means 81, and the control means 4 also outputs an operation instruction to the heating interception means 82.

Under the assumption that the temperature of the molten-salt electrolyte battery 18 increases abnormally for some reason, a predetermined upper limit temperature (e.g., 100° C.) that is higher than the normal operating temperature is set in advance and stored in the control means 4. When the temperature inputted from the temperature detection means 85 into the control means 4 becomes the upper limit temperature, the control means 4 outputs an operation instruction to the cooling means 5, and the cooling means 5 cools the molten-salt electrolyte battery 18 with a cooling medium. In such a manner, in the case where abnormal heat generation occurs in the molten-salt electrolyte battery 18, the molten-salt electrolyte battery 18 is cooled by the cooling medium, and therefore, the temperature of the molten-salt electrolyte battery 18 can be quickly decreased to a safe temperature.

Furthermore, the control means 4 may also output an operation instruction to the heating interception means 82 at the same time as the control means 4 outputs an operation instruction to the cooling means 5. In this case, while the molten-salt electrolyte battery 18 is cooled by the cooling medium, heating is also stopped. In such a manner, in the case where abnormal heat generation occurs in the molten-salt electrolyte battery 18, by shutting off the power of the heating means 81 which is provided in order to heat the molten-salt electrolyte battery 18 to a predetermined temperature, the molten-salt electrolyte battery 18 is not further heated, and the temperature of the molten-salt electrolyte battery 18 can be decreased more efficiently.

Furthermore, two-stage upper limit temperatures of the molten-salt electrolyte battery 18 may be set. For example, the first upper limit temperature which is higher than the normal operating temperature may be set at a first temperature (e.g., 100° C.), and the second upper limit temperature which is higher than the first temperature may be set at a second temperature (e.g., 120° C.) such that an operation instruction is outputted to the heating interception means 82 when the temperature inputted from the temperature detection means 85 into the control means 4 becomes the first temperature, and an operation instruction is outputted to the cooling means 5 when the temperature inputted from the temperature detection means 85 into the control means 4 becomes the second temperature. In this case, at the point when abnormal heat generation occurs in the molten-salt electrolyte battery 18 and the temperature becomes the first temperature, only heating is stopped. In the case where, the temperature of the molten-salt electrolyte battery 18 is not decreased by stopping of heating alone, and the temperature becomes the second temperature, cooling is further performed using the cooling medium. In such a manner, when a large amount of heat is generated such that the temperature is not decreased only by shutting off of the power of the heating means 81, cooling is performed using the cooling medium in order to decrease the temperature to a safe temperature quickly. When a very small amount of heat is generated such that the temperature is decreased by shutting off of the power of the heating means 81, the temperature of the molten-salt electrolyte battery 18 is not decreased excessively, and it is possible to quickly perform heating to the temperature that is equal to or higher than the temperature at which the molten-salt electrolyte melts in the process of operating the molten-salt electrolyte battery 18 again, thus being efficient.

Next, means for cooling the molten-salt electrolyte battery using a cooling medium will be described with reference to FIGS. 2 to 4. FIGS. 2 to 4 are each a schematic view showing an example of a cooling means 5. In a cooling means 5 shown in FIG. 2, a cooling medium 51 stored in a cooling medium container 53 is jetted from a jet orifice 54 toward a molten-salt electrolyte battery 18.

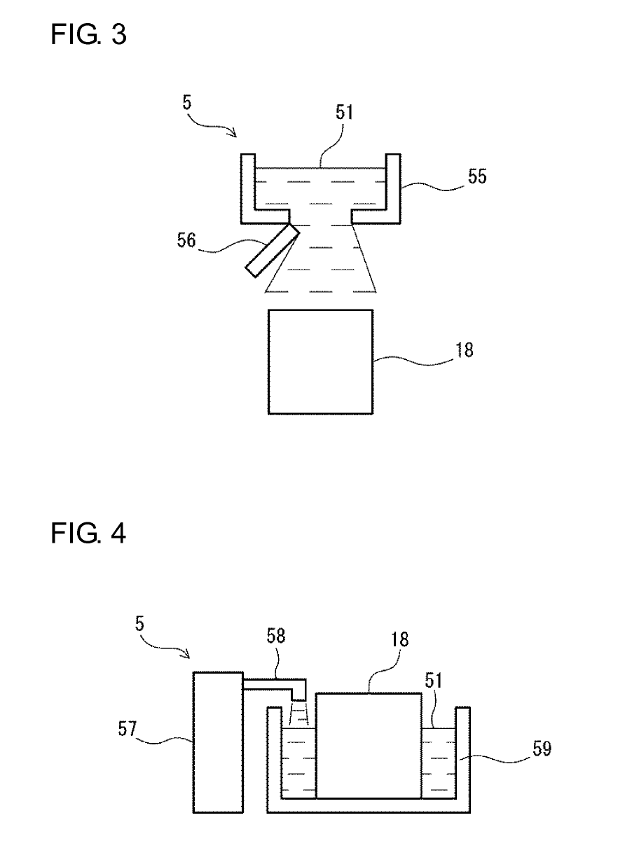

In a cooling means 5 shown in FIG. 3, a cooling medium container 55 which stores a cooling medium 51 is arranged above a molten-salt electrolyte battery 18, and by removing a bottom plate 56 of the cooling medium container 55, the cooling medium 51 is scattered on the molten-salt electrolyte battery 18.

In a cooling means 5 shown in FIG. 4, a molten-salt electrolyte battery 18 is placed inside a vessel 59, and by pouring a cooling medium 51 stored in a cooling medium container 57 through a nozzle 58 into the vessel 59, the molten-salt electrolyte battery 18 is immersed in the cooling medium 51.

The cooling medium 51 shown in each of FIGS. 2 to 4 is not particularly limited as long as it can cool the molten-salt electrolyte battery 18. As the cooling means 5 of the molten-salt electrolyte battery device according to the present invention, besides the means shown in FIGS. 2 to 4, an ordinary water-cooled type cooling means or air-cooled type cooling means can be employed.

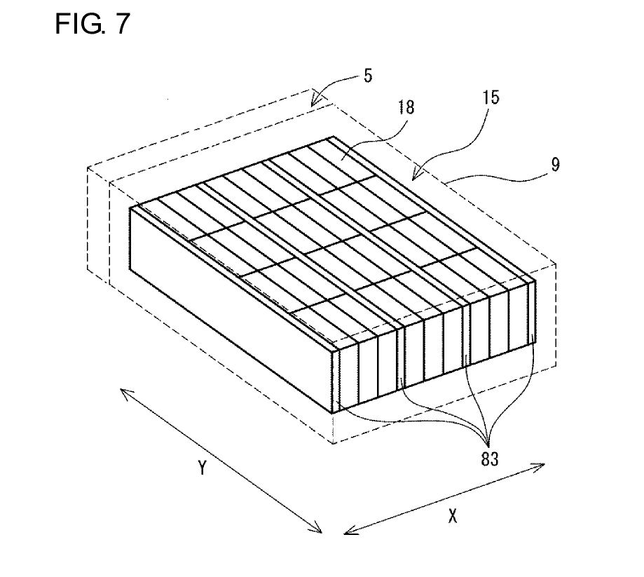

For example, a water-cooled type cooling means may be a cooling means 5 in which cooling water is introduced into a cooling water coil configured to be arranged on a molten-salt electrolyte battery 18. Regarding an air-cooled type cooling means, for example, insulation of an insulating container 9 shown in FIG. 7 is released or suspended, and a molten-salt electrolyte battery 18 can be air-cooled by an air blower or the like. In particular, in order to rapidly cool the molten-salt electrolyte battery 18, use of liquid nitrogen is preferable. Since liquid nitrogen has a lower temperature than other cooling mediums (e.g., water), it can effectively cool the molten-salt electrolyte battery 18. Furthermore, liquid nitrogen has high versatility and is easy to handle compared with liquid hydrogen, liquid helium, or the like which has a lower temperature than liquid nitrogen. Furthermore, since nitrogen does not react with the salt of the molten-salt electrolyte battery, the battery is not degraded or damaged. When the temperature of the battery is increased again to melt the molten-salt electrolyte, it is possible to discharge and charge the battery again.

Furthermore, the cooling means 5 may cool the molten-salt electrolyte battery 18 at least to a temperature at which the molten-salt electrolyte coagulates. In the molten-salt electrolyte battery 18, when the temperature of the molten-salt electrolyte becomes a predetermined temperature or lower (e.g., room temperature) and the molten-salt electrolyte coagulates, reactions, such as discharging, charging, and gas generation, do not occur. Thus, the molten-salt electrolyte battery 18 is safe.

Furthermore, the amount of the cooling medium 51 used in the cooling means 5 shown in each of FIGS. 2 to 4, the direction of the jet orifice 54, and the number and position of bottom plates 56, and the like may be appropriately designed depending on the structure, position, and the like of the molten-salt electrolyte battery device 1. Furthermore, the configuration of the cooling means 5 is not limited to the configurations shown in FIGS. 2 to 4.

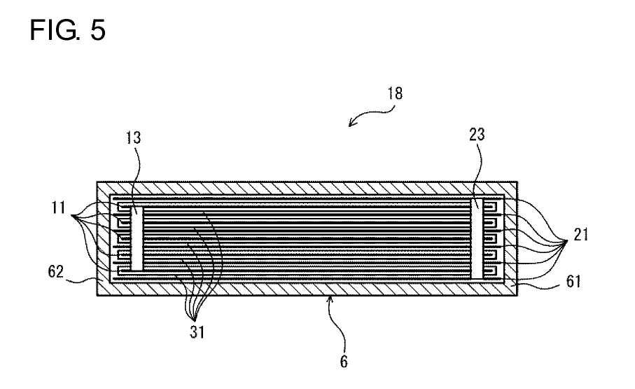

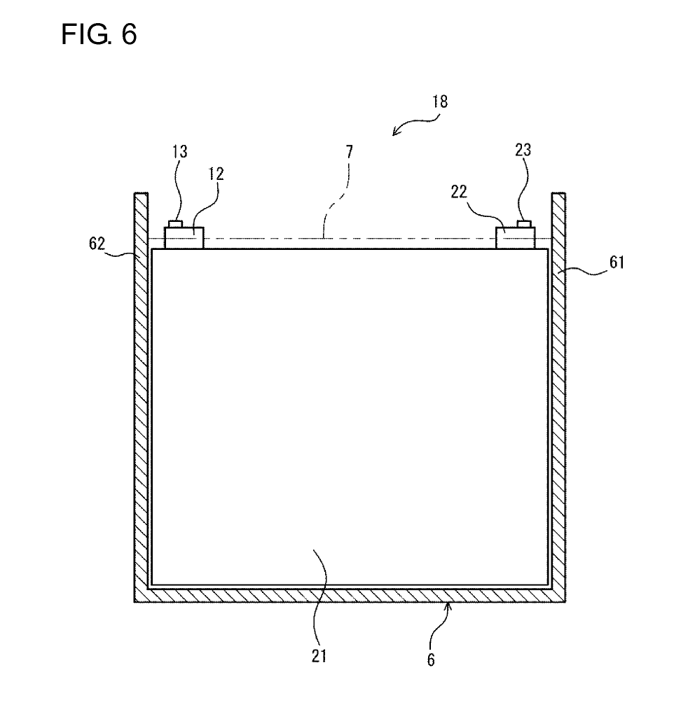

The structure of the molten-salt electrolyte battery 18 will now be described. FIG. 5 is a schematic top view showing an example of a structure of the molten-salt electrolyte battery 18. FIG. 6 is a schematic perspective front view of the molten-salt electrolyte battery 18. In FIGS. 5 and 6, reference sign 6 denotes a battery case composed of an aluminum alloy, and the battery case 6 has a substantially rectangular parallelepiped shape that is hollow with a bottom. The inside of the battery case 6 is subjected to insulation treatment by fluorine coating or alumite treatment. Six negative electrodes 21 and five positive electrodes 11 each being contained in a bag-shaped separator 31 are arranged in parallel in a lateral direction (front-back direction in the drawing) in the battery case 6. A negative electrode 21, a separator 31, and a positive electrode 11 constitute one power generating element, and in FIG. 5, five power generating elements are stacked.

The lower end of a rectangular tab (conductor) 22 for extracting a current is joined to a portion of the upper end of the negative electrode 21 near a side wall 61 of the battery case 6. The upper end of the tab 22 is joined to the lower surface of a rectangular plate-shaped tab lead 23. The lower end of a rectangular tab 12 for extracting a current is joined to a portion of the upper end of each positive electrode 11 near another side wall 62 of the buttery case 6. The upper end of the tab 12 is joined to the lower surface of a rectangular plate-shaped tab lead 13. Thus, five power generating elements each including a negative electrode 21, a separator 31, and a positive electrode 11 are connected in parallel.

The tab leads 13 and 23 function as external electrodes for connecting the whole stacked power generating elements including positive electrodes 11 and negative electrodes 21 to an external electrical circuit and are located above the liquid level of a molten-salt electrolyte 7.

The separator 31 is composed of a non-woven glass fabric that has resistance to the molten-salt electrolyte 7 at the temperature at which the molten-salt electrolyte battery 18 operates, which is porous and formed into a bag shape. The separator 31, together with the negative electrode 21 and the positive electrode 11, is immersed, about 10 mm below the liquid level, in the molten-salt electrolyte 7 filled in the substantially rectangular parallelepiped battery case 6. This allows a slight decrease in the liquid level.

The molten-salt electrolyte 7 includes a bis(fluorosulfonyl)imide (FSI) or bis(trifluoromethylsulfonyl)imide (TFSI) anion and a cation of sodium and/or potassium, although not limited thereto.

In the present invention, a molten-salt electrolyte battery device 1 having a structure shown in the block diagram of FIG. 1 may be configured to include a single molten-salt electrolyte battery 18. Alternatively, a plurality of molten-salt electrolyte batteries 18 may be combined to constitute a molten-salt electrolyte battery unit, and a molten-salt electrolyte battery device 1 having a structure shown in the block diagram of FIG. 1 may be configured to include the molten-salt electrolyte battery unit. An example of the structure of a molten-salt electrolyte battery unit including a plurality of molten-salt electrolyte batteries 18 will be described below. FIG. 7 is a schematic oblique perspective view showing a structure of a molten-salt electrolyte battery unit 15. Four molten-salt electrolyte batteries 18 are connected in the Y direction to form a group, and nine groups are arranged in the X direction. Three groups are connected in the X direction, and a plate-shaped heater 83 is inserted between each three groups. Heaters 83 are also disposed on both ends in the X direction. In FIG. 7, thirty-six molten-salt electrolyte batteries 18, and four heaters 83 constitute the molten-salt electrolyte battery unit 15.

The molten-salt electrolyte batteries 18 constituting the molten-salt electrolyte battery unit 15 are electrically connected in series and in parallel. For example, in FIG. 7, four batteries connected in the Y direction are connected in series, and nine groups arranged in the X direction are connected in parallel. Furthermore, the heaters 83 each serve as the heating means 81 described with reference to FIG. 1. That is, the molten-salt electrolyte battery unit 15 in this example includes the molten-salt electrolyte battery 18 and the heating means 81 shown in FIG. 1.

Furthermore, by housing the molten-salt electrolyte battery unit 15 in an insulating container 9, the molten-salt electrolyte batteries 18 are efficiently heated and kept warm. When the molten-salt electrolyte batteries 18 are housed in the insulating container 9 in such a manner, by turning off of the power of the heating means 81 alone, it takes a long time to decrease the temperature of the molten-salt electrolyte batteries 18. Therefore, it is effective to cool the molten-salt electrolyte batteries 18 with a cooling medium.

### EXAMPLES

The present invention will be described in more details on the basis of examples.

### Example 1

As an example, molten-salt electrolyte batteries 18, each being the same as that shown in FIGS. 5 and 6, were fabricated, and a molten-salt electrolyte battery unit 15 and a cooling means 5 shown in FIG. 7 were further fabricated. As a heating means, a plate-like heater 83 as that shown in FIG. 7 was used. As a temperature detection means, a thermocouple was used, and the thermocouple was attached to the surface of each molten-salt electrolyte battery 18. Cooling was configured such that insulation of the insulating container 9 was released and by jetting a cooling medium 51 from the cooling means 5, the molten-salt electrolyte batteries 18 were cooled. As the cooling medium 51, liquid nitrogen was used.

The molten-salt electrolyte batteries were heated to 80° C. by the heaters 83, and a discharge-charge operation was performed. Then, when liquid nitrogen was jetted to the surface of the molten-salt electrolyte batteries 18 during the discharge-charge operation, in about 30 seconds, the molten-salt electrolyte in the entire molten-salt electrolyte battery unit 15 was solidified, and battery reactions stopped.

Subsequently, when the molten-salt electrolyte batteries 18 were heated again to 80° C. by the heaters 83, it was possible to perform a discharge and charge operation in the same manner as that before jetting liquid nitrogen.

### Example 2

Two types of molten-salt electrolyte battery devices were fabricated as in Example 1 except that the cooling means 5 only was changed in the molten-salt electrolyte batteries having the structure shown in Example 1. In one molten-salt electrolyte battery device, a water-cooled type cooling coil was provided which was capable of introducing cooling water between adjacent molten-salt electrolyte batteries 18 shown in FIG. 7. In another molten-salt electrolyte battery device, an air-cooled type cooling means was provided such that, by releasing or suspending insulation of the insulating container 9 of FIG. 7, the molten-salt electrolyte batteries 18 could be cooled by a blast fan.

In this state, under the assumption of an abnormal increase in the temperature, the two molten-salt electrolyte battery devices were controlled to 100° C. that was higher than the normal operation temperature, and then the heating means was stopped. Subsequently, in one device, cooling was started by supply of room temperature tap water. In the other device, insulation of the insulating container 9 was released or suspended, and cooling was started by sending room temperature air to the molten-salt electrolyte batteries 18 using a blast fan.

The results showed that the cooling time required for the temperature to reach the melting point of the molten-salt electrolyte was about 5 minutes in the water-cooled type cooling means and about 30 minutes in the air-cooled type cooling means.

### Comparative Example 1

As a comparative example, a molten-salt electrolyte battery unit that is the same as that of Example 1 was fabricated. A heating means and a temperature detection means were fabricated as in Example 1.

The molten-salt electrolyte batteries were heated to 80° C. by the heaters, and a discharge-charge operation was performed. Subsequently, the power of the heaters was shut off during the discharge-charge operation. As a result, it took about 2 hours for battery reactions to stop owing to solidification of the molten-salt electrolyte in the entire molten-salt electrolyte battery unit.

It was confirmed from the results of Examples 1 and 2 and Comparative Example 1 that by jetting a cooling medium, such as liquid nitrogen, to the molten-salt electrolyte batteries or by cooling with a water-cooled type cooling means or air-cooled type cooling means, the temperature of the batteries was quickly decreased, and battery reactions were stopped safely compared with the case where only the power of the heaters was shut off.

The results show that in a molten-salt electrolyte battery device provided with a cooling means according to the present invention, the temperature of the molten-salt electrolyte battery body can be decreased in a very short period of time. An increase in temperature during rapid discharging can be quickly controlled to the preset temperature, and even an increase in temperature in an abnormal situation, such as internal short-circuiting, can be effectively controlled highly safely.

1. A molten-salt electrolyte battery device provided with a molten-salt electrolyte battery which uses a molten-salt electrolyte, characterized by comprising:
a temperature detection means which detects the temperature of the molten-salt electrolyte battery;
a cooling means which cools the molten-salt electrolyte battery with a cooling medium; and
a control means into which a signal from the temperature detection means is inputted and which outputs an operation instruction to the cooling means.

2. The molten-salt electrolyte battery device according to claim 1, characterized in that the device further comprises a heating means which heats the molten-salt electrolyte battery and a heating interception means which shuts off the power of the heating means, and
the control means further outputs an operation instruction to the heating interception means.

3. The molten-salt electrolyte battery device according to claim 2, characterized in that the control means outputs an operation instruction to the heating interception means when the temperature of the molten-salt electrolyte battery becomes a predetermined first temperature or higher, and
the control means outputs an operation instruction to the cooling means when the temperature of the molten-salt electrolyte battery becomes a second temperature or higher, the second temperature being higher than the first temperature.

4. The molten-salt electrolyte battery device according to claim 1, characterized in that the cooling means cools the molten-salt electrolyte battery at least to a temperature at which the molten-salt electrolyte coagulates.

5. The molten-salt electrolyte battery device according claim 1, characterized in that the cooling medium is liquid nitrogen.

6. The molten-salt electrolyte battery device according to claim 1, characterized in that the cooling means is a water-cooled type cooling means or air-cooled type cooling means.

7. The molten-salt electrolyte battery device according to claim 1, characterized in that the molten-salt electrolyte battery is housed in an insulating container.
